(19) United States
(12) Patent Application Publication
(10) Pub. No.: US 2026/0371297 A1
(43) Pub. Date: Nov. 19, 2026

(54) OBTAINING LOCATION INFORMATION AND/OR SIDELINK COMMUNICATION INFORMATION ASSOCIATED WITH AN OUT OF COVERAGE PERIOD

(71) Applicant: Telefonaktiebolaget LM Ericsson (publ), Stockholm (SE)

(72) Inventors: Badawi YAMINE, Beirut (LB); Joakim ÅKESSON, Hovås (SE)

(73) Assignee: Telefonaktiebolaget LM Ericsson (publ), Stockholm (SE)

(21) Appl. No.: 19/158,779

(22) PCT Filed: Feb. 24, 2023
(86) PCT No.: PCT/SE2023/050169

§ 371 Date: Aug. 21, 2025

(51) Int. Cl. H04W 64/00; H04W 76/14

(52) U.S. Cl. CPC H04W 64/00; H04W 76/14

(57) ABSTRACT

A method performed by a first user equipment, UE. The method comprising the first UE detecting that the first UE is out of a coverage of a network. The method further comprises, after detecting the first UE is out of the coverage of a network, the first UE detecting that the first UE is no longer out of the coverage of the network (e.g., the UE determining that it can obtain system information broadcast by a network node of the network). The method further comprises, after detecting that the first UE is no longer out of the coverage of the network, the first UE transmitting to a network node of the network a message comprising: i) location information that the first UE obtained in response to detecting that the first UE is no longer out of coverage and indicating a location of the first UE and/or ii) an indicator indicating a) whether or not the UE could discover a second UE and/or b) whether or not the UE could establish sidelink communication with the second UE.

### TECHNICAL FIELD

Disclosed are embodiments related to obtaining location information and/or sidelink communication information associated with an out of coverage period.

### BACKGROUND

In a 3rd Generation Partnership Project (3GPP) wireless network, a first user equipment (UE) has multiple options when communicating with a second UE. In a first option, the first UE may communicate with the second UE using an intermediate node. For example, communications between the two UEs may pass through a network node of a radio access network (RAN), e.g., a Next Generation NodeB (gNB).

In a second option, the first UE may communicate directly with the second UE. In such scenarios, the first UE may exchange information directly with the second UE. Such communications may be referred to as Device to Device (D2D) communications. The link used in direct communications may be referred to as sidelink.

The second option allows a UE, UE1, located in an out of coverage area (i.e., an area in which UE1 is not able to communication with any RAN network node) to obtain network access by establishing a sidelink communication with a second UE that is able to receive service from a RAN network node (hereafter “base station”). In other words, UE2 will act as a relay between UE1 and the base station

UE1 may be located in an out of coverage area due to UE1 moving to an area not covered by any base station or due to a network outage (e.g., an outage caused by a natural disaster or an outage caused by a hardware or software failure).

### SUMMARY

Certain challenges presently exist. For example, there may be a scenario where a network operator requires location information about the location of UEs during a cell outage. The network operator may use the location information to understand the scope of the cell outage and the status of the UEs. The UEs may collect location information and later transmit the location information to the network operator. In this scenario, however, the current standard only allows the network operator to collect location information associated with the UEs detecting they are out of coverage of the network.

Accordingly, there is a need for obtaining location information associated with the UEs detecting network coverage after experiencing an out of coverage event.

In another example, a UE may be capable of establishing a sidelink communication with another UE device during an out of coverage event. Using the sidelink communication, the UE may be able to establish a connection with the network. In this example, however, the current standard does not allow the network operator to know which UEs were able to establish a sidelink communication during the out of coverage event and which were not. Thus, there is a need for obtaining information about whether a UE was able to, or had the potential to, establish a sidelink communication during an out of coverage period.

Accordingly, in one aspect there is provided a system. The system includes a first user equipment, UE; a first network node for determining whether the first UE had the potential of establishing a sidelink communication with a second UE; a second network node for determining the location of the UEs, wherein the second network node serves a first cell; and a management node. The first UE is configured to detect that the first UE is out of a coverage of a network (e.g., UE detects that it cannot obtain system information broadcast by any RAN node of the network).

The first UE is further configured to, after detecting the first UE is out of the coverage of the network, detect that the first UE is no longer out of the coverage of the network (e.g., the UE determining that it can obtain system information broadcast by a network node of the network). The first UE is further configured to, after detecting that the first UE is no longer out of the coverage of the network, the first UE transmitting to a network node of the network a message comprising: i) location information that the first UE obtained in response to detecting that the first UE is no longer out of coverage and indicating a location of the first UE and/or ii) an indicator indicating a) whether or not the UE could discover a third UE and/or b) whether or not the UE could had the potential to establish sidelink communication with the third UE.

The first network node is configured to obtain first location information indicating a location of the first UE. The first network node is further configured to obtain second location information a location of the second UE. The first network node is further configured to determine a distance between the location of the first UE and the location of the second UE. The first network node is further configured to determine that the distance is less than a threshold. The first network node is further configured to, as a result of determining that the distance is less than the threshold, determine that the first UE had the potential to establish sidelink communication with the second UE.

The second network node is configured to detect that a second cell has experienced an outage, wherein the second cell is a neighbor of the first cell. The second network node is further configured to, as a result of detecting that the second cell has experienced an outage, for at least a certain amount of time, determine the location of each UE that connects to the first cell.

The management node is configured to detect that the second cell has experienced the outage. The management node is further configured to determine a third network node that serves a third cell that neighbors the second cell. The management node is further configured to transmit to the third network node an instruction to, for at least a certain amount of time, determine the location of each UE that connects to the third cell within a certain period of time.

In another aspect, there is provided a method performed by a first user equipment, UE. The method includes the first UE detecting that the first UE is out of a coverage of a network. The method further includes, after detecting the first UE is out of the coverage of a network, the first UE detecting that the first UE is no longer out of the coverage of the network (e.g., the UE determining that it can obtain system information broadcast by a network node of the network). The method further includes, after detecting that the first UE is no longer out of the coverage of the network, the first UE transmitting to a network node of the network a message comprising: i) location information that the first UE obtained in response to detecting that the first UE is no longer out of coverage and indicating a location of the first UE and/or ii) an indicator indicating a) whether or not the UE could discover a second UE and/or b) whether or not the UE could establish sidelink communication with the second UE.

In yet another aspect, there is provided a method performed by a network node for determining whether a first user equipment, UE, had the potential of establishing a sidelink communication with a second UE. The method includes obtaining first location information indicating a location of the first UE. The method further includes obtaining second location information a location of the second UE. The method further includes determining a distance between the location of the first UE and the location of the second UE. The method further includes determining that the distance is less than a threshold. The method further includes, as a result of determining that the distance is less than the threshold, determining that the first UE had the potential to establish sidelink communication with the second UE.

In another aspect, there is provided a method performed by a network node for determining the location of user equipments, UEs, wherein the network node serves a first cell. The method includes detecting that a second cell has experienced an outage, wherein the second cell is a neighbor of the first cell. The method further includes, as a result of detecting that the second cell has experienced an outage, for at least a certain amount of time, determining the location of each UE that connects to the first cell.

Accordingly, in one aspect, there is provided a method performed by a management node for determining the location of user equipments, UEs. The method includes detecting that a first cell served by a first network node has experienced an outage. The method further includes determining a second network node that serves a second cell that neighbors the first cell. The method further includes transmitting to the second network node an instruction to, for at least a certain amount of time, determine the location of each UE that connects to the second cell within a certain period of time.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus that is configured to perform the methods disclosed herein. The apparatus may include memory and processing circuitry coupled to the memory.

An advantage of the embodiments disclosed herein is that they provide a way of informing a network whether a UE was moving or stationary while located in an area of out of coverage. Once radio coverage is brought to the area, e.g., a drone carrying a Radio Base Station, the network could then prioritize calls of UEs which were not moving during the out of coverage period.

The out of coverage period may have been caused by a natural disaster that has damaged the radio equipment and/or transmissions of local radio nodes.

Another advantage of the embodiments disclosed herein is they provide a way of detecting whether a UE located in an out of coverage area established, or potentially could have established, a sidelink communication. Prioritizing isolated UEs, those unable to establish a sidelink communication, will help a network operator save human lives, especially when a natural disaster caused the loss of coverage.

### BRIEF DESCRIPTION OF THE DRAWINGS

The accompanying drawings, which are incorporated herein and form part of the specification, illustrate various embodiments.

FIG. 1 illustrates a wireless network system according to some embodiments.

FIG. 2 is a flowchart illustrating a process according to an embodiment.

FIG. 3 is a flowchart illustrating a process according to an embodiment.

FIG. 4 is a flowchart illustrating a process according to an embodiment.

FIG. 5 is a flowchart illustrating a process according to an embodiment.

FIG. 6 illustrates an apparatus according to some embodiments.

FIG. 7 illustrates an apparatus according to some embodiments.

### DETAILED DESCRIPTION

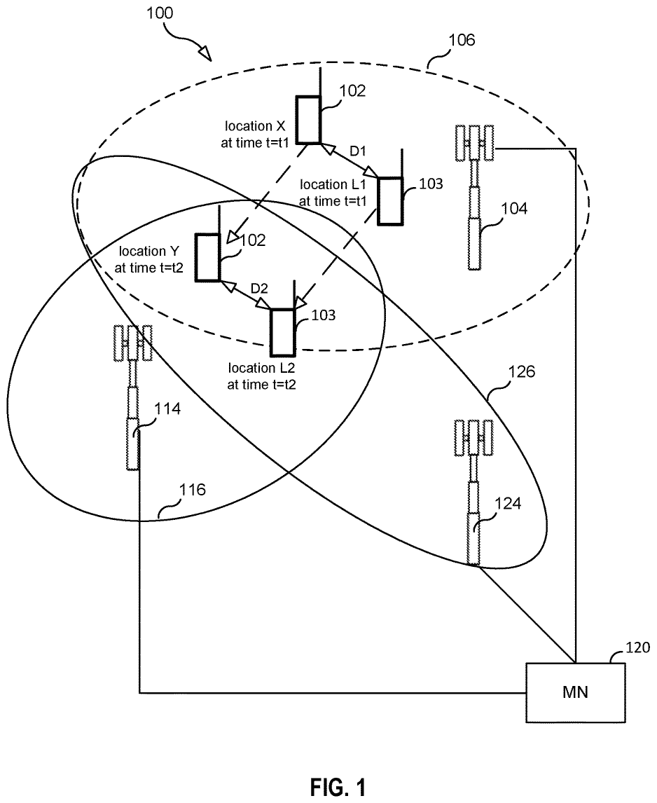

FIG. 1 shows a portion of a wireless network system 100 according to some embodiments. The wireless network system 100 comprises a UE 102, a UE 103, a first network node 104 (e.g., a RAN network node (a.k.a., base station)) providing service in a coverage area 106 (a.k.a., cell), a second network node 114 providing service in a coverage area 116, a third network node 124 providing service in a coverage area 126, and a management node (MN) 120 of a management system (e.g., an Operations Support System (OSS)). First network node 104 may be configured to provide access to a network for UEs within its service area 106 (e.g., UE 102). UE 102 may be configured to transmit messages towards first network node 104.

At times, first network node 104 may experience an event preventing first network node 104 from providing network access to the UEs within its service area 106. For example, first network node 104 may experience an unexpected outage (e.g., equipment failure) or a planned outage (e.g., upgrading the software of its equipment). Additionally, the wireless network system 100 may experience a natural disaster which damages the equipment of first network node 104. In such scenarios, UE 102 loses access to the network (i.e., experiences an out of coverage event).

Upon detecting that UE 102 is out of coverage of the network, UE 102 may perform different actions depending on whether UE 102 is in connected mode or idle mode. In embodiments where UE 102 is in connected mode, UE 102 may perform actions in accordance with 3GPP Technical Specification (TS) 38.331 V17.3.0 (Radio Resource Control (RRC) protocol). As part of the protocol, when UE 102 regains network access, UE 102 may report to the network node its location when it detected the loss of coverage, a timestamp associated with the loss of coverage, and time elapsed since the loss of coverage.

In embodiments where UE 102 is in idle mode, UE 102 may perform actions in accordance with 3GPP TS 37.320 V17.2.0 (Radio measurement collection for Minimization of Drive Tests (MDT)) (hereafter “TS 37.320”). In such embodiments, UE 102 may log its location when it detects a loss of coverage.

In order to obtain a better understanding of the out of coverage event, it may be desirable for the network to obtain location information indicating the location of the UE at or near the time UE 102 detected network coverage after the initial loss of coverage (this location is referred to herein as location “Y”). If the time between losing coverage and regaining coverage is small, e.g., UE 102 passes by a radio coverage hole and triggers a call reestablishment procedure, then the additional location information may be less useful. However, if the time between losing coverage and regaining coverage is large, then the additional location information (i.e., the information indication location Y) may be useful for the network operator in order to fix the radio coverage hole or the network failure. For example, the network operator may use the additional location information to estimate the size and area of a radio coverage hole.

By knowing the location of UE 102 at the time (or near the time) the UE detected a loss of coverage (this location is referred to herein as location “X”) and the location of the UE 102 at or near the time the UE regained network coverage (location Y), the network operator may calculate whether UE 102 was stuck in one location (e.g., location X and location Y being close together) or whether UE 102 was moving (e.g., location Y being distant from location X) during the cell outage.

### 1. Location Of A UE After Detecting Coverage

### 1.1 UE Calculated Location

As indicated by the dashed arrowed-line in FIG. 1, UE 102 may move from a first location (location X) to a second location (location Y), as also indicated in FIG. 1, UE 103 may move from a first location (location L1) to a second location (location L2).

At the first location, UE 102 may detect that it is out of coverage of the network due to, for example, a failure of network node 104. In some embodiments, UE 102 may transmit location information to a node in the network (e.g., network node 114) identifying the first location (i.e., location X) after reestablishing a connection with the network or it may log the location information.

At a later point in time when UE 102 is at the second location within cells 106 and 116, UE 102 may determine that it is no longer out of coverage (e.g., UE 102 is able to establish an RRC connection with network node 104 or 114) and, as a result, UE 102 may determine its current location (a.k.a., location Y). At the later point in time when UE 102 determines that it is no longer out of coverage, the UE may be in connected mode or idle mode. These two different scenarios are described below.

### Connected Mode

After determining that it is no longer out of coverage, UE 102 will either trigger a connection set up or trigger a connection reestablishment. UE 102 triggers a call reestablishment (e.g., transmits to a network node a connection reestablishment request (e.g., an RRCConnectionReestablishmentRequest message)) if 1) UE 102 detects cell coverage within a period of time after detecting being out of coverage and 2) the detected cell coverage is from a cell with the same radio access technology (RAT) as the cell previously providing coverage from before the outage event. Accordingly, if network node 114 uses the same RAT as network node 104, then, if UE 102 detects that it can hear network node 114 within the given period of time (i.e., before a certain timer expires) but not network node 104, then UE 102 sends the connection reestablishment message to network node 114. Likewise, if UE 102 detects that it can hear network node 104 within the given period of time (i.e., before a certain timer expires), then UE 102 sends the connection reestablishment message to network node 104.

In some embodiments, after triggering the call reestablishment by transmitting the RRCConnectionReestablishmentRequest message, UE 102 receives an RRCReestablishment message from the network node to which the RRCConnectionReestablishmentRequest message was sent. In response to receiving the RRCReestablishment message, UE 102 transmits to the network node an RRCReestablishmentComplete message. In some embodiments, UE 102 includes in the RRCReestablishmentComplete message an indicator indicating that a radio link failure report is available. The radio link failure report may contain the location information indicating UE 102's current location.

The radio link failure report may also include location information indicating the location of UE 102 at or near the time UE 102 detected the out of coverage event. The network node may then request the radio link failure report from UE 102. In some embodiments, UE 102 does not include the indicator indicating that the radio link failure report is available in the RRCReestablishmentComplete message unless an RRCReconfiguration message includes an indicator indicating that UE 102 should later include the location information indicating UE 102's current location.

UE 102 triggers a connection setup (e.g., transmits to a network node a connection setup request (e.g., an RRCSetupRequest message)) if 1) UE 102 detects cell coverage after the above mentioned certain timer expires or 2) the detected cell coverage is from a cell with different RAT as the cell previously providing coverage from before the outage event. Accordingly, if network node 114 uses a different RAT than network node 104, then, if UE 102 detects that it can hear network node 114 within the given period of time (e.g. before a certain timer expires) but not network node 104, then UE 102 sends the connection setup request message to network node 114. Likewise, if UE 102 detects that it can hear network node 104 after the timer expires, then UE 102 sends the connection setup message to network node 104.

In some embodiments, after triggering the connection setup by transmitting the RRCSetupRequest message, UE 102 receives a message from the network node to which the RRCSetupRequest message was sent. In response to receiving the message from the network node, UE 102 transmits to the network node an RRCSetupComplete message. In some embodiments, UE 102 includes in the RRCSetupComplete message an indicator indicating a radio link failure report is available. The radio link failure report may contain the location information indicating UE 102's current location.

The radio link failure report may also contain location information indicating the location of UE 102 at or near the time UE 102 detected the out of coverage event. In some embodiments, UE 102 does not include the indicator indicating the availability of the radio link report in the RRCSetupComplete message unless a message from the network node includes an indicator indicating that UE 102 should include the location information indicating UE 102's current location in the RRCSetupComplete message. In another embodiment, UE 102 may include the location information indicating UE 102's current location in the RRCSetupRequest message.

### Idle Mode

In some embodiments, UE 102 may be in idle mode during the entire out of coverage event. In such embodiments, a new log event may be added to TS 37.320. The new log event may ask UE 102 to determine location information indicating the UE's location at the time (or near the time) the UE detected the end of the out of coverage event. The location information may be stored in an MDT log.

After storing the location information, UE 102 may trigger a signaling procedure (e.g., a location update procedure or a service request procedure if the UE has data to sends to the network) that includes the UE sending a message to a network node. The message may be an RRC message such as the RRCSetupComplete message. In one embodiment, the message sent to the network node indicates that UE 102 has a MDT log report available. The network may then decide whether to request the MDT log report from UE 102.

For example, in one scenario, UE 102, in idle mode, may detect a new cell after detecting loss of coverage from first network node 104. If the new cell has a different tracking area code (TAC) than the TAC of first network node 104, then UE 102 may immediately trigger a signaling procedure (e.g., a tracking area update procedure or registration procedure). The signaling procedure may include the UE transmitting a message on the random access channel (RACH) followed the UE transmitting an RRC message (e.g., RRCSetupComplete) including a TAU request or registration request. In one embodiment, the RRC message includes information (e.g., a flag) indicating that UE 102 has a MDT log report available. The network may then decide whether to request the MDT log report from UE 102.

As another example, in one scenario, UE 102, in idle mode, may detect a page intended for the UE or may detect that an application running on the UE has data to send to the nework. In response, UE 102 may immediately trigger a signaling procedure that includes the UE transmitting a message on the random access channel (RACH) followed the UE transmitting an RRC message (e.g., RRCSetupComplete). In one embodiment, the RRC message includes information (e.g., a flag) indicating that UE 102 has a MDT log report available. The network may then decide whether to request the MDT log report from UE 102.

In some embodiments, after an event causing a network node outage, e.g., a natural disaster, a drone carrying a network node may be deployed to take over for the network node experiencing the outage. The network node carried by the drone may employ the same RAT as the network node that experienced the outage. In addition, the network node on the drone may have a TAC different than the cell in outage. As such, when UEs detect a cell provided by the network node of the drone, the UEs may trigger the location update procedure. As such, the UEs in idle mode may indicate the availability of its MDT log to the network using a parameter in RRCSetupComplete message.

### 1.2 Network Calculated Location

In some embodiments, instead of (or in addition to) UE 102 determining its location at or near the time UE 102 detects the end of the outage event (e.g., at or near time UE 102 can obtain system information transmitted by a network node that enables UE 102 to establish a connection with the network node), a network node serving the UE can determine the UE's location at or near the time the outage event ended for the UE (i.e., location Y).

In some embodiments, each time a cell, e.g., 5G cell, experiences a planned or an unexpected outage, MN 120 detects the outage, and in response to detecting the outage, the MN may identify all network nodes serving cells neighboring the failed cell, e.g., 5G and 4G neighboring cells, and instructs the network nodes serving the neighboring cells to determine the location of every UE attempting to connect to the network node via one of the neighboring cells within a period of time or until the outage is over (i.e., as long as the failed cell remains down) or a subset of said UEs. The subset of UE includes only those UEs that are attempting to connect to the network node because the UE experienced a radio link failure. In one embodiment, the network node can determine that a UE belongs to the subset based on the RRCReestablishmentComplete message or a RRCSetupComplete message transmitted by the UE because, if the UE experiences a link failure, the message may contain an indicator indicating the presence of a radio link failure report. The radio link failure report may contain the UE location when it has experienced the link failure.

Using FIG. 1 as an illustrative example, MN 120 may detect that network node 104 experienced an outage. MN 120 may then identify that network node 114 serves a neighboring cell (i.e., cell 116) and/or that network node 124 serves a neighboring cell (i.e., cell 126). MN 120 may then asks network nodes 114 and/or 124 to determine the location of every UE that initiates a connection setup procedure with network nodes 114 and/or 124 (or said subset of said UEs). As such, as UE 102 enters the service area 116 of the second network node 114 and then initiates a connection setup procedure (e.g., sends RRCSetupComplete), the second network node 114 may determine UE 102's current location. Additionally, as UE 102 enters the service area 126 of the third network node 124 and then initiates a connection setup procedure (e.g., sends RRCSetupComplete), the third network node 124 may determine UE 102's current location.

Network nodes 114 and/or 116 may use any existing location procedure to determine UE 102's current location. For example, network node 114 may use Observed Time Difference Of Arrival (OTDOA) to determine UE 102's current location.

In some embodiments, when the failed cell recovers, MN 120 may also instruct the network node serving the failed cell that has recovered to determine the location of every UE attempting to connect to the network node within a defined time window (e.g., 10 minutes from when the cell went back online) (or said subset of said UEs). Such embodiments may be particularly beneficial when a cell experiences an outage for a few minutes and in an area with few neighboring cells.

In another embodiment, as a result of detecting a cell outage, MN 120 may deploy a drone carrying a RAN network node to serve the area that was served by the cell experiencing the outage. The network node on the drone may be configured to determine the location of ever UE attempting to connect to the network node within a defined time window (e.g., 10 minutes from when the cell went back online or until the cell comes back online) (or said subset of said UEs). The cell served by the network node on the drone may have a different TAC than the failed cell so that a location update procedure is triggered immediately upon a UE determining the different TAC.

### 1.3 Deducing UE Movement

After a network node obtains first location information indicating the location of a UE at the time (or near the time) the UE lost network service (location X) and second location information indicating the location of the UE at the time (or near the time) the UE regained network service (location Y), the network node may determine the movement of UE 102 during the out of coverage period. The location information may be obtained using any of the embodiments described above.

By comparing location Y with location X, the network node can determine a movement of UE 102 during the out of coverage period. In some embodiments, the determined movement may be small indicating UE 102 stayed in the same location during the out of coverage period. In another embodiment, the determined movement may be greater than a distance threshold (e.g., few meters) indicating UE 102 moved during the out of coverage period.

### 2. Sidelink Communications

In some embodiments, first network node 104 may experience an outage which causes UEs in its service area 106 to lose service. UEs within the service area of a working cell, such as UE 103 being within the service area 116 of network node 114, may be able to maintain a connection with the network via network node 114. UEs not located within the service area of a working cell, such as first network node 104, may experience an out of coverage event.

UE 102, however, may be able to reestablish connection with the network by establishing sidelink communication with the UE 103. The UE 103 may then act as a relay transmitting messages between UE 102 and network node 114. It may be beneficial for the network to know whether UE 102 was able to establish a sidelink communication with another UE, such as UE 103, during the out of coverage period. When UE 102 is out of coverage, hence not receiving radio coverage from any cell in the network, only sidelink calls may be available.

### 2.1 Ue Reporting Sidelink Communication

In some embodiments, UE 102 may report information about sidelink communications to the network. The information about sidelink communications may be a new parameter added to an existing specification. For example, the new parameter may be denoted here as sl_comm_estb_or_not, and may be added to the existing TS 38.331 specification. This new parameter may be added to MeasResults Information Element (IE), which is an IE that may be included in an RRC MeasurementReport message.

In some embodiments, the new parameter may indicate whether UE 102 was able to successfully establish a sidelink communication with another UE. The new parameter may be embodied as a single bit which UE 102 sets to 1 when it successfully establishes a sidelink communication with another UE during the out of coverage period. In other embodiments, the new parameter may indicate whether UE 102 could have potentially established a sidelink communication during the out of coverage period. Each UE may have a set sidelink communication range. UE 102 may have the potential to establish a sidelink communication when it detects another UE (e.g., UE 103) within its sidelink communication range and the another UE has the capability to function as a UE-to-Network relay. In yet another embodiment, the new parameter may indicate both whether UE 102 established a sidelink communication during the out of coverage period and whether UE 102 had the potential to establish a sidelink communication during the out of coverage period.

UE 102 may report the new parameter, sl_comm_estb_or_not, during the first signaling procedure that is triggered by UE 102 when it detects radio coverage from a cell. During the same signaling procedure, e.g., TAU procedure or a service request, UE 102 may also report location information indicating location X and location information indicating location Y.

Accordingly, by the end of the first signaling procedure triggered by UE 102, the network will be aware of location X, location Y, and the value sl_comm_estb_or_not. As such, the network will be aware if UE 102 was stationary, during timeSinceFailure which corresponds to the time that elapsed since the last radio link failure, and that was not able to make a sidelink communication.

### 2.2. Determining The Potential For Sidelink Communication

In some embodiments, rather than, or in addition to, UE 102 reporting whether it was able to establish a sidelink communication with another UE during an out of coverage period, the network (e.g., MN 120 or another network node in the network) may determine whether UE 102 had the potential to establish a sidelink communication during the out of coverage period.

Without information from the UEs, the network's knowledge about sidelink activation among UEs in the network may be limited. Even if there is a sidelink capable device nearby, the network may not know if those two UEs are authorized to communicate with each other using sidelink communications. When using mission critical (MC) services, off network communication encryption keys may be exchanged in advance between users that are allowed to communicate (e.g. belong to the same organization). The network operator may not have access to this information as it may be private to the provider of the MC service.

Using any of the embodiments described above, MN 120 (or another network node) may obtain location information indicating location X, location Y, location L1, and location L2. Locations X and L1 indicate the location of UE 102 and UE 103, respectively, at or near the time the out of coverage period began. Locations Y and L2 indicate the location of UE 102 and UE 103, respectively, at or near the time the out of coverage period ended.

In some embodiments, MN 120 calculates a distance from location X to location L1 and compares this distance to a distance threshold. The distance threshold may be a maximum distance the UEs are capable of establishing a sidelink communication link. If the distance from location X to location L1 is less than the distance threshold, then MN 120 determines that at time t=t1 UE 102 had the potential to establish a sidelink communication with the UE 103. If, however, the distance from location X to location L1 is greater than the distance threshold, then at that moment in time (i.e., t=t1), UE 102 could not communicate using sidelink communications with the UE 103.

Similarly, MN 120 calculates a distance from location Y to location L2 and compares this distance to the distance threshold. If the distance from location Y to location L2 is less than the distance threshold, then MN 120 determines that at time t=t2 UE 102 had the potential to establish a sidelink communication with the UE 103. If, however, the distance from location Y to location L2 is greater than the distance threshold, then at that moment in time (i.e., t=t2), UE 102 could not communicate using sidelink communications with the UE 103.

In some embodiments, the network may obtain location information for a plurality of UEs, the plurality of UEs including the UE 102 and UE 103. In such embodiments, the network may compare the location of each UE of the plurality of UEs after each UE detected it was out of coverage with the first location. The network may determine the closest UE to the first location and then calculate a distance between the closest UE and the first location. This distance calculation may be used to determine whether UE 102 had the potential to establish a sidelink communication at the first location.

The network may also compare the location of each UE of the plurality of UEs after each UE detected it was no longer out of coverage. The network may determine the closest UE to UE 102 at location Y and then calculate a distance between the closest UE and location Y. This distance calculation may be used to determine whether UE 102 had the potential to establish a sidelink communication at location Y. The network may perform the above calculations for each UE of the plurality of UEs.

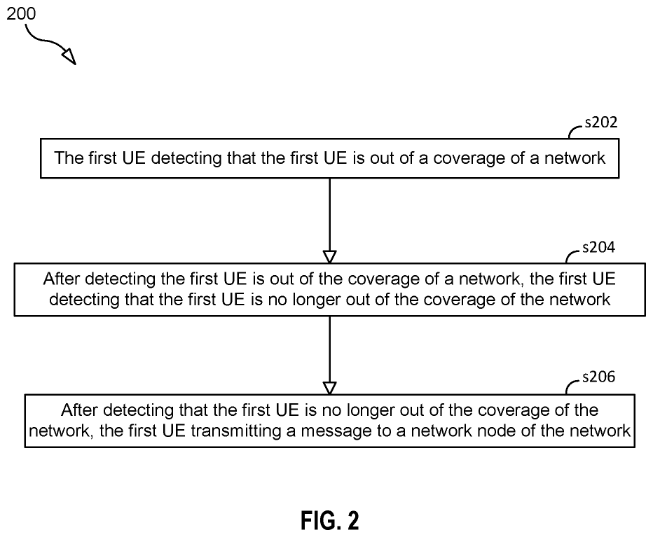

FIG. 2 is a flow chart illustrating a process 200, according to an embodiment, performed by a first user equipment, UE. Process 200 may begin in step s202. Step s202 comprises the first UE detecting that the first UE is out of a coverage of a network. Step s204 comprises, after detecting the first UE is out of the coverage of a network, the first UE detecting that the first UE is no longer out of the coverage of the network (e.g., the UE determining that it can obtain system information broadcast by a network node of the network). Step s206 comprise, after detecting that the first UE is no longer out of the coverage of the network, the first UE transmitting to a network node of the network a message comprising: i) location information that the first UE obtained in response to detecting that the first UE is no longer out of coverage and indicating a location of the first UE and/or ii) an indicator indicating a) whether or not the UE could discover a second UE and/or b) whether or not the UE could establish sidelink communication with the second UE.

In some embodiments, the message is a radio resource control (RRC) message (e.g., RRCReestablishmentcomplete or RRCSetupComplete).

In some embodiments, the first UE transmits the message comprising the location information and/or the indicator after initiating an initial access procedure with the network node.

In some embodiments, the message comprising the location information and/or the indicator is an RRCSetUpComplete message.

In some embodiments, the process 200 further comprises, prior to transmitting the message, storing the location information in a log.

In some embodiments, the process 200 further comprises receiving a log request message, wherein the log request message was transmitted by the network node of the network, wherein the message comprises the location information, and the message is a response message responsive to the log request message.

In some embodiments, the message is transmitted as part of a signaling procedure to reestablish or setup a connection.

In some embodiments, the process 200 further comprises, prior to the first UE transmitting to the network the message, the first UE transmitting to the network node an initial message comprising a report indicator indicating a report; after transmitting to the network node the initial message, receiving a report request transmitted by the network node, wherein the first UE transmits to the network node of the network the message as a result of receiving the report request.

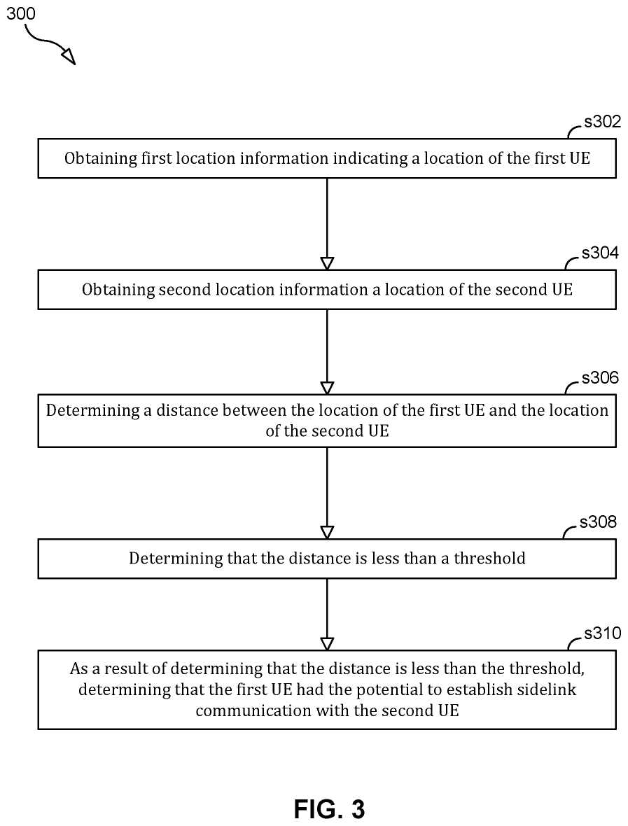

FIG. 3 is a flow chart illustrating a process 300, according to an embodiment, performed by a network node for determining whether a first user equipment, UE, had the potential of establishing a sidelink communication with a second UE. Process 300 may begin in step s302. Step s302 comprises obtaining first location information indicating a location of the first UE. Step s304 comprises obtaining second location information a location of the second UE. Step s306 comprises determining a distance between the location of the first UE and the location of the second UE. Step s308 comprises determining that the distance is less than a threshold. Step s310 comprises, as a result of determining that the distance is less than the threshold, determining that the first UE had the potential to establish sidelink communication with the second UE.

In some embodiments, the first location information indicates a location of the first UE associated with the first UE losing network coverage, and wherein the second location information indicates a location of the second UE associated with the second UE losing network coverage.

In some embodiments, the first location information indicates a location of the first UE associated with the first UE regaining network coverage after losing network coverage, and wherein the second location information indicates a location of the second UE associated with the second UE regaining network coverage after losing network coverage.

In some embodiments, threshold is a maximum distance which the first UE is capable of establishing a sidelink communication.

In some embodiments, the first location information indicates a location of the first UE associated with the first UE losing network coverage, and wherein the second location information indicates a location of the second UE associated with the second UE having network coverage.

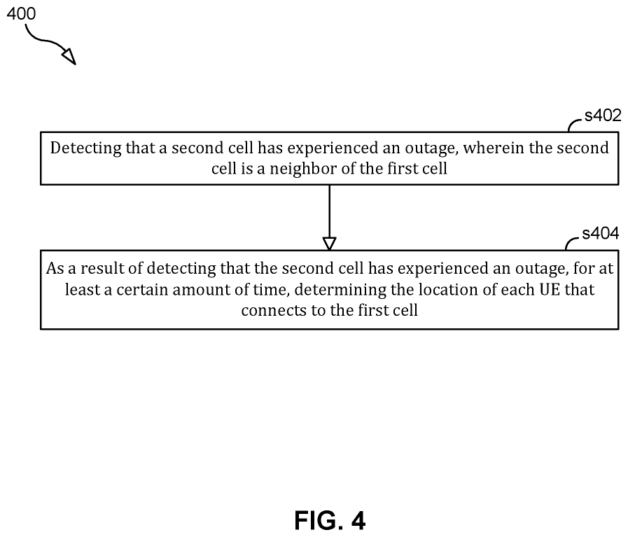

FIG. 4 is a flow chart illustrating a process 400, according to an embodiment, performed by a network node for determining the location of user equipments, UEs, wherein the network node serves a first cell. Process 400 may begin in step s402. Step s402 comprises detecting that a second cell has experienced an outage, wherein the second cell is a neighbor of the first cell. Step s404 comprises as a result of detecting that the second cell has experienced an outage, for at least a certain amount of time, determining the location of each UE that connects to the first cell.

In some embodiments, determining the location of each UE that connects to the first cell comprises using observed time difference of arrival.

In some embodiments, process 400 further comprises obtaining location information indicating an initial location of a first UE associated with the second cell experiencing the outage, wherein the first UE connects to the first cell; and determining a movement of the first UE using the location information and the determined location of the first UE after the first UE connects to the first cell In some embodiments, process 400 further comprises comparing the movement of the first UE to a movement threshold; and as a result of the movement being less than the movement threshold, determining that the first UE was stationary.

In some embodiments, process 400 further comprises determining whether each UE that connects to the first cell transmits a radio link failure report; and determining the location of each UE that connects to the first cell as a result of receiving the radio link failure report.

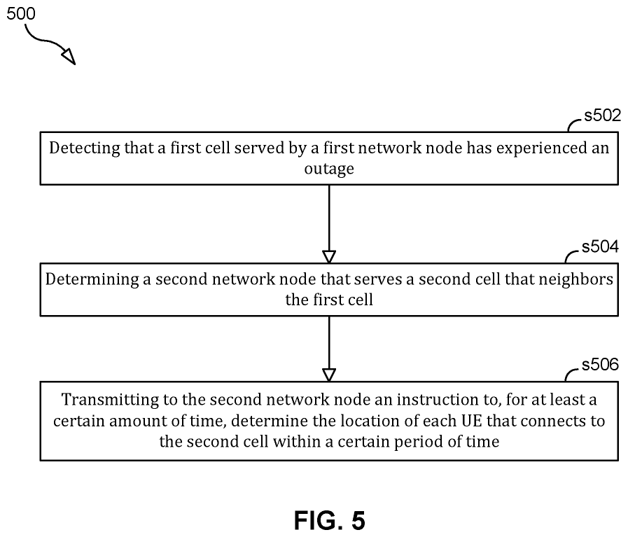

FIG. 5 is a flow chart illustrating a process 500, according to an embodiment, performed by a management node for determining the location of user equipments, UEs. Process 500 may begin in step s502. Step s502 comprises detecting that a first cell served by a first network node has experienced an outage. Step s504 comprises determining a second network node that serves a second cell that neighbors the first cell. Step s506 comprises transmitting to the second network node an instruction to, for at least a certain amount of time, determine the location of each UE that connects to the second cell within a certain period of time.

In some embodiments, process 500 further comprises transmitting to the first network node an instruction to, for at least a certain amount of time after the outage ends, determine the location of each UE that connects to the first cell within a certain period of time.

In some embodiments, process 500 further comprises dispatching a drone to serve a service area of the first cell; and instructing the drone to, for at least a certain amount of time, determine the location of each UE that connects to the drone within a certain period of time.

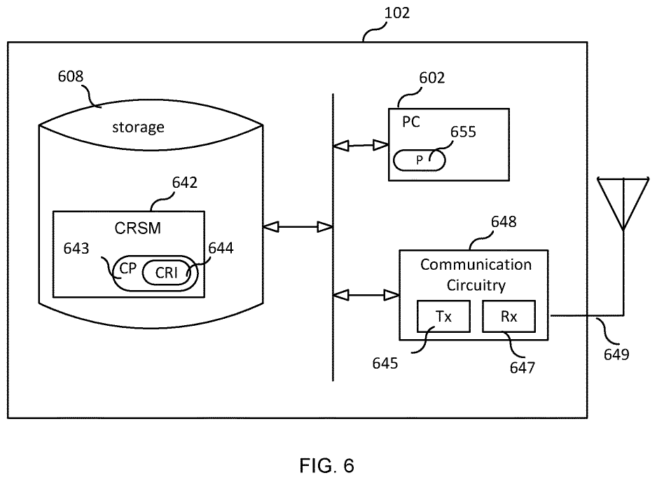

FIG. 6 is a block diagram of UE 102, or any other UE described above, according to some embodiments. As shown in FIG. 6, the UE first UE 102 may comprise: processing circuitry (PC) 602, which may include one or more processors (P) 655 (e.g., one or more general purpose microprocessors and/or one or more other processors, such as an application specific integrated circuit (ASIC), field-programmable gate arrays (FPGAs), and the like); communication circuitry 648, which is coupled to an antenna arrangement 649 comprising one or more antennas and which comprises a transmitter (Tx) 645 and a receiver (Rx) 647 for enabling UE 102 to transmit data and receive data (e.g., wirelessly transmit/receive data); and a storage unit (a.k.a., “data storage system”) 608, which may include one or more non-volatile storage devices and/or one or more volatile storage devices. In embodiments where PC 602 includes a programmable processor, a computer readable storage medium (CRSM) 642 may be provided. CRSM 642 may store a computer program (CP) 643 comprising computer readable instructions (CRI) 644. CRSM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes UE 102 to perform steps described herein (e.g., steps described herein with reference to the flow charts). In other embodiments, UE 102 may be configured to perform steps described herein without the need for code. That is, for example, PC 602 may consist merely of one or more ASICs. Hence, the features of the embodiments described herein may be implemented in hardware and/or software.

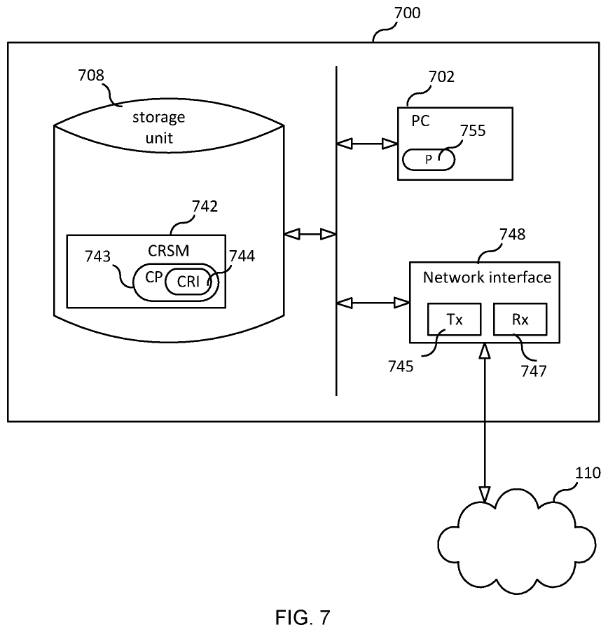

FIG. 7 is a block diagram of network node 700 (e.g., first network node 104 and/or the second network node 114/404), according to some embodiments. As shown in FIG. 7, network node 700 may comprise: processing circuitry (PC) 702, which may include one or more processors (P) 755 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network node 700 may be a distributed computing apparatus); at least one network interface 748 (e.g., a physical interface or air interface) comprising a transmitter (Tx) 745 and a receiver (Rx) 747 for enabling network node 700 to transmit data to and receive data from other nodes connected to a network 110 (e.g., an Internet Protocol (IP) network) to which network interface 748 is connected (physically or wirelessly) (e.g., network interface 748 may be coupled to an antenna arrangement comprising one or more antennas for enabling network node 700 to wirelessly transmit/receive data); and a storage unit (a.k.a., “data storage system”) 708, which may include one or more non-volatile storage devices and/or one or more volatile storage devices. In embodiments where PC 702 includes a programmable processor, a computer readable storage medium (CRSM) 742 may be provided. CRSM 742 may store a computer program (CP) 743 comprising computer readable instructions (CRI) 744.

CRSM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes network node 700 to perform steps described herein (e.g., steps described herein with reference to the flow charts). In other embodiments, network node 700 may be configured to perform steps described herein without the need for code. That is, for example, PC 702 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A system comprising:
a first user equipment (UE);
a first network node for determining whether the first UE had the potential of establishing a sidelink communication with a second UE;
a second network node for determining the location of the UEs, wherein the second network node serves a first cell; and
a management node wherein
the first UE is configured to:
detect that the first UE is out of a coverage of a network;
after detecting the first UE is out of the coverage of the network, detect that the first UE is no longer out of the coverage of the network; and
after detecting that the first UE is no longer out of the coverage of the network, the first UE transmitting to a network node of the network a message comprising: i) location information that the first UE obtained in response to detecting that the first UE is no longer out of coverage and indicating a location of the first UE and/or ii) an indicator indicating a) whether or not the UE could discover a third UE and/or b) whether or not the UE could had the potential to establish sidelink communication with the third UE,
the first network node is configured to:
obtain first location information indicating a location of the first UE;
obtain second location information a location of the second UE;
determine a distance between the location of the first UE and the location of the second UE;
determine whether the distance is less than a threshold; and
as a result of determining that the distance is less than the threshold, determine that the first UE had the potential to establish sidelink communication with the second UE,
the second network node is configured to:
detect that a second cell has experienced an outage, wherein the second cell is a neighbor of the first cell;
as a result of detecting that the second cell has experienced an outage, for at least a certain amount of time, determine the location of each UE that connects to the first cell, and
the management node is configured to:
detect that the second cell has experienced the outage;
determine a third network node that serves a third cell that neighbors the second cell; and
transmit to the third network node an instruction to, for at least a certain amount of time, determine the location of each UE that connects to the third cell within a certain period of time.

2. A method performed by a first user equipment, (UE), the method comprising:
the first UE detecting that the first UE is out of a coverage of a network;
after detecting the first UE is out of the coverage of a network, the first UE detecting that the first UE is no longer out of the coverage of the network (e.g., the UE determining that it can obtain system information broadcast by a network node of the network); and
after detecting that the first UE is no longer out of the coverage of the network, the first UE transmitting to a network node of the network a message comprising: i) location information that the first UE obtained in response to detecting that the first UE is no longer out of coverage and indicating a location of the first UE and/or ii) an indicator indicating a) whether or not the UE could discover a second UE and/or b) whether or not the UE could establish sidelink communication with the second UE.

3. The method of claim 2, wherein the message is a radio resource control (RRC) message.

4. The method of claim 2, wherein the first UE transmits the message comprising the location information and/or the indicator after initiating an initial access procedure with the network node.

5-6. (canceled)

7. The method of claim 1, wherein the method further comprises:
receiving a log request message, wherein the log request message was transmitted by the network node of the network, wherein
the message comprises the location information, and
the message is a response message responsive to the log request message.

8. The method of claim 2, wherein the message is transmitted as part of a signaling procedure to reestablish a connection or setup a connection.

9. The method of claim wherein the method further comprises:
prior to the first UE transmitting to the network the message, the first UE transmitting to the network node an initial message comprising a report indicator indicating a report; and
after transmitting to the network node the initial message, receiving a report request transmitted by the network node, wherein
the first UE transmits to the network node of the network the message as a result of receiving the report request.

10. A method performed by a network node the method comprising:
obtaining first location information indicating a location of a first user equipment (UE);
obtaining second location information indicating a location of a second UE;
determining a distance between the location of the first UE and the location of the second UE;
determining that the distance is less than a threshold; and
as a result of determining that the distance is less than the threshold, determining that the first UE had the potential to establish sidelink communication with the second UE.

11. The method of claim 10, wherein
the first location information indicates a location of the first UE associated with the first UE losing network coverage, and
the second location information indicates a location of the second UE associated with the second UE losing network coverage.

12. The method of claim 10, wherein
the first location information indicates a location of the first UE associated with the first UE regaining network coverage after losing network coverage, and
the second location information indicates a location of the second UE associated with the second UE regaining network coverage after losing network coverage.

13. The method of claim 10, wherein
the first location information indicates a location of the first UE associated with the first UE losing network coverage, and
the second location information indicates a location of the second UE associated with the second UE having network coverage.

14-22. (canceled)

23. A first user equipment (UE), the first UE comprising:
memory; and
processing circuitry, wherein the first UE is configured to:
detect that the first UE is out of a coverage of a network;
after detecting the first UE is out of the coverage of a network, detect that the first UE is no longer out of the coverage of the network obtain; and
after detecting that the first UE is no longer out of the coverage of the network, transmit to a network node of the network a message comprising: i) location information that the first UE obtained in response to detecting that the first UE is no longer out of coverage and indicating a location of the first UE and/or ii) an indicator indicating a) whether or not the first UE could discover a second UE and/or b) whether or not the first UE could establish sidelink communication with the second UE.

24. The first UE of claim 23, wherein the message is a radio resource control (RRC) message.

25-30. (canceled)

31. A network node, the network node comprising:
memory; and
processing circuitry, wherein the network node is configured to:
obtain first location information indicating a location of a first user equipment (UE);
obtain second location information a location of a second UE;
determine a distance between the location of the first UE and the location of the second UE;
determine that the distance is less than a threshold; and
as a result of determining that the distance is less than the threshold, determine that the first UE had the potential to establish sidelink communication with the second UE.

32. The network node of claim 31, wherein
the first location information indicates a location of the first UE associated with the first UE losing network coverage, and
the second location information indicates a location of the second UE associated with the second UE losing network coverage.

33-43. (canceled)
